(19) United States
(12) Patent Application Publication
(10) Pub. No.: US 2026/0145510 A1
(43) Pub. Date: May 28, 2026

(54) INTAKE ASSEMBLY FOR AN OFF-ROAD VEHICLE

(71) Applicant: Polaris Industries Inc., Medina, MN (US)

(72) Inventors: John B. Pircon, Wyoming, MN (US); Alex R. Scheuerell, Wyoming, MN (US); Andrew T. Ives, Wyoming, MN (US); Dennis J. Lutz, Wyoming, MN (US); Molly C. Steinberg, Wyoming, MN (US); Jacob M. Olson, Wyoming, MN (US); Jake E. Wendt, Wyoming, MN (US)

(21) Appl. No.: 18/956,428

(22) Filed: Nov. 22, 2024

(51) Int. Cl. B60K 11/08; B60K 11/04; B60K 17/04; B62D 25/06; F16H 57/04

(52) U.S. Cl. CPC B60K 11/08; B60K 11/04; B60K 17/04; B62D 25/06; F16H 57/0416

(57) ABSTRACT

A vehicle is provided, comprising a plurality of ground engaging members and a frame supported by the plurality of ground engaging members. The frame defines an operator area. A powertrain is supported by the frame and the powertrain comprises a prime mover including a prime mover air inlet and a transmission operably coupled between the prime mover and at least one ground engaging member of the plurality of ground engaging members. The transmission comprises a transmission air inlet. A roof is supported by the frame and positioned above the operator area and the roof defines a first roof inlet fluidly coupled with the prime mover air inlet and a second roof inlet fluidly coupled with the transmission air inlet.

### FIELD OF THE DISCLOSURE

The present disclosure relates to an air intake assembly for a vehicle and methods of routing air flow.

### BACKGROUND OF THE DISCLOSURE

Utility and recreational vehicles often face constraints for obtaining air for cooling and operating a powertrain. Systems for obtaining clean and cool air for a powertrain and an associated cooling assembly is disclosed herein.

### SUMMARY OF THE DISCLOSURE

In an embodiment of the present disclosure, a vehicle is provided. The vehicle may include a plurality of ground engaging members and a frame supported by the plurality of ground engaging members. The frame may define an operator area. A powertrain may be supported by the frame and the powertrain comprises a prime mover including a prime mover air inlet and a transmission operably coupled between the prime mover and at least one ground engaging member of the plurality of ground engaging members. The transmission comprises a transmission air inlet. A roof may be supported by the frame and may define a first roof inlet fluidly coupled with the prime mover air inlet and a second roof inlet fluidly coupled with the transmission air inlet.

In embodiments, the roof comprises a body portion and a first shroud portion spaced from a body portion, the first shroud portion and the body portion defining at least a portion of the first roof inlet.

In embodiments, the roof comprises a second shroud portion, and the second shroud portion and the body portion define at least a portion of the second roof inlet.

In embodiments, the roof comprises a third shroud portion positioned laterally intermediate the first shroud portion and the second shroud portion.

In embodiments, the vehicle further comprises a cooling assembly operably coupled with the prime mover, and the third shroud portion defines a third roof inlet fluidly coupled with the cooling assembly.

In embodiments, the first roof inlet is laterally spaced from the second roof inlet.

In embodiments, the vehicle further comprises further comprises a cooling assembly and the roof defines a third roof inlet, and the third roof inlet is fluidly coupled with a portion of the cooling assembly.

In embodiments, the vehicle further comprises a first shroud portion coupled to the roof and extending generally downwardly into the operator area, and the operator area being partially defined by a rear wall and the first shroud portion extending between the roof and the rear wall.

In embodiments, the first shroud portion defines a portion of a cooling system channel extending between the third roof inlet and the cooling assembly.

In embodiments, each of the first roof inlet, second roof inlet, and third roof inlet are laterally spaced apart.

In embodiments, the third roof inlet is positioned laterally intermediate the first roof inlet and the second roof inlet.

In embodiments, the third roof inlet has a lateral width greater than a lateral width of the first roof inlet or the second roof inlet.

In embodiments, the inlet is positioned longitudinally aligned with the seat.

In yet another embodiment of the present disclosure, a vehicle is provided. The vehicle comprises a plurality of ground engaging members and a frame supported by the plurality of ground engaging members and the frame defines an operator area. A powertrain is supported by the frame, the powertrain comprising a prime mover including a prime mover air inlet, and a transmission operably coupled between the prime mover and at least one ground engaging member of the plurality of ground engaging members. The transmission comprises at least one transmission air inlet and a plurality of conduits comprising at least one conduit fluidly coupled with the prime mover air inlet and at least one conduit fluidly coupled with the at least one transmission air inlet. Further, a roof is supported by the frame and positioned above the operator area, the roof defining a plurality of inlets including a first portion of inlets and a second portion of inlets, wherein the first portion of inlets is fluidly coupled to at least a first conduit of the plurality of conduits and the second portion of inlets is fluidly coupled to at least a second conduit of the plurality of conduits.

In embodiments, the plurality of inlets are vertically aligned.

In embodiments, the plurality of inlets are laterally spaced.

In embodiments, the at least one transmission air inlet includes a first transmission air inlet and a second transmission air inlet. The first portion of inlets is fluidly coupled to the first conduit of the plurality of conduits and a third conduit of the plurality of conduits, and the first conduit is fluidly coupled with the first transmission air inlet and the second conduit is fluidly coupled with the second transmission air inlet.

In embodiments, the roof includes a first shroud portion and a second shroud portion laterally spaced from the first shroud portion, each of the first shroud portion and second shroud portion defining separate inlet of the plurality of inlets.

In embodiments, the plurality of inlets includes a third portion of inlets, and the third portion of inlets is positioned laterally intermediate the first portion of inlets and the second portion of inlets.

In embodiments, the vehicle further comprises a cooling assembly operably coupled to the powertrain, and the third portion of inlets is fluidly coupled to the cooling assembly.

In embodiments, the first portion of inlets includes a first inlet, the second portion of inlets includes a second inlet, and a third portion of inlets includes a third inlet. The first inlet is fluidly coupled with the prime mover air inlet, the second inlet is fluidly coupled with the transmission air inlet, and the third inlet is fluidly coupled with a cooling assembly.

In embodiments, the cooling assembly comprises a radiator, and the transmission is positioned vertically lower than the radiator.

In yet another embodiment of the present disclosure, a roof assembly is provided. A roof assembly comprises a body member, a first shroud portion coupled to the body member, and a first inlet defined by the first shroud portion and the body member. Further, a second shroud portion is coupled to the body member, and a second inlet defined by the second shroud portion and the body member.

In embodiments, the roof assembly further comprises a third shroud portion coupled to the body member, a third inlet defined by the third shroud portion and the body member.

In embodiments, the first inlet is positioned laterally intermediate the second inlet and the third inlet.

In embodiments, the first inlet has a first width, the second inlet has a second width, the third inlet has a third width, and the first width is greater than the second width and the third width.

In embodiments, the roof assembly further comprises a third shroud coupled to the body member, an outlet defined by the third shroud, and a channel defined between the first inlet and the outlet by each of the first shroud portion, the body member, and the third shroud.

In embodiments, the third shroud extends below the body member.

### BRIEF DESCRIPTION OF THE DRAWINGS

FIG. 1 is a front left perspective view of a vehicle of the present disclosure;

FIG. 2 is a rear right perspective view of the vehicle of FIG. 1;

FIG. 3 is a left view of the vehicle of FIG. 1;

FIG. 4 is a top view of the vehicle of FIG. 1;

FIG. 5 is a front view of the vehicle of FIG. 1;

FIG. 5A is a front view of the vehicle of FIG. 1;

FIG. 6 is a diagrammatic view of a powertrain of the vehicle of FIG. 1;

FIG. 7 is a rear perspective view of a portion of the powertrain of FIG. 6;

FIG. 8 is a front perspective view of a portion of the powertrain of FIG. 6;

FIG. 9 is a rear diagrammatic view of a portion of the powertrain of FIG. 6;

FIG. 10 is a front left perspective view of a vehicle of the present disclosure;

FIG. 11 is a rear left perspective view of the vehicle of FIG. 10;

FIG. 12 is a left view of the vehicle of FIG. 10;

FIG. 13 is a top view of the vehicle of FIG. 10;

FIG. 14 is a front view of the vehicle of FIG. 10;

FIG. 15 is a diagrammatic view of a powertrain of the vehicle of FIG. 10;

FIG. 16A is a front left perspective view of a portion of a powertrain of the vehicle of FIG. 10 shown next to a rear wall and a roof assembly of the vehicle of FIG. 10;

FIG. 16B is a rear right perspective view of a portion of a powertrain of the vehicle of FIG. 10 shown next to a rear wall and a roof assembly of the vehicle of FIG. 10;

FIG. 17A is an exploded view of a roof assembly of the vehicle of FIG. 10;

FIG. 17B is a portion of an alternate roof assembly of a vehicle of the present disclosure;

FIG. 17C is a left view of a vehicle of the present disclosure with the alternate roof assembly of FIG. 17B;

FIG. 18 is a front view of a portion of an operator area of the vehicle of FIG. 10; and

FIG. 19 is a diagrammatic view of a portion of a powertrain of the vehicle of FIG. 10.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

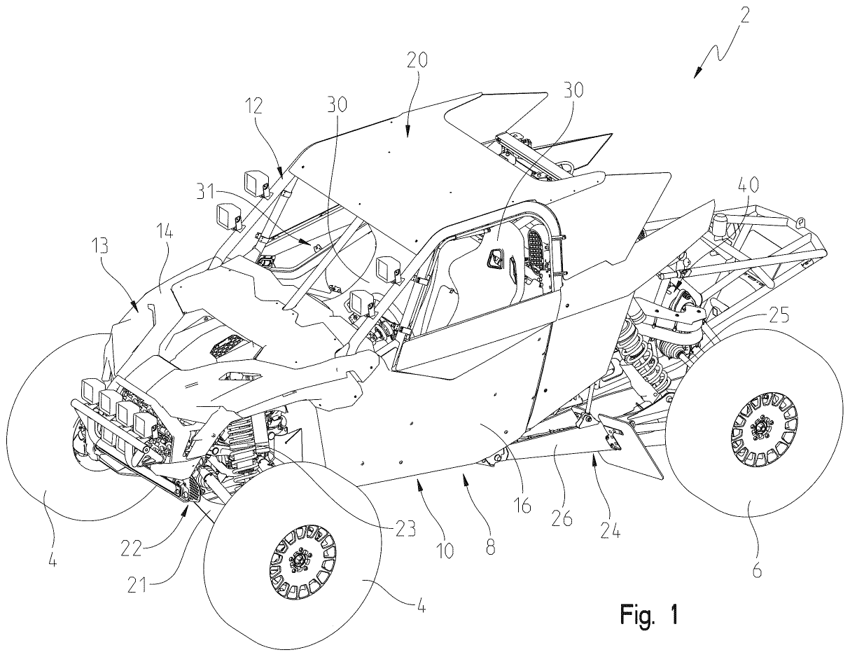

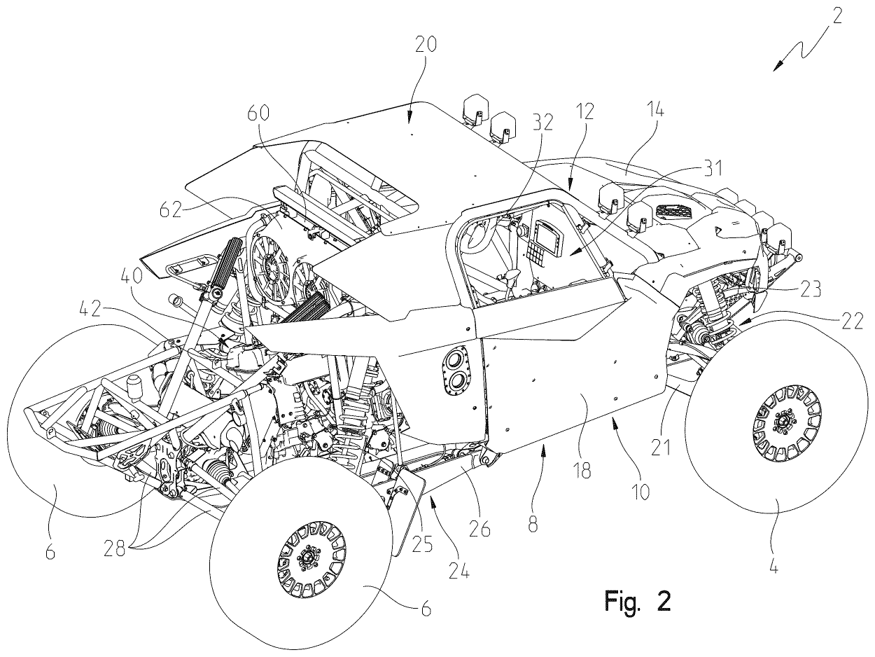

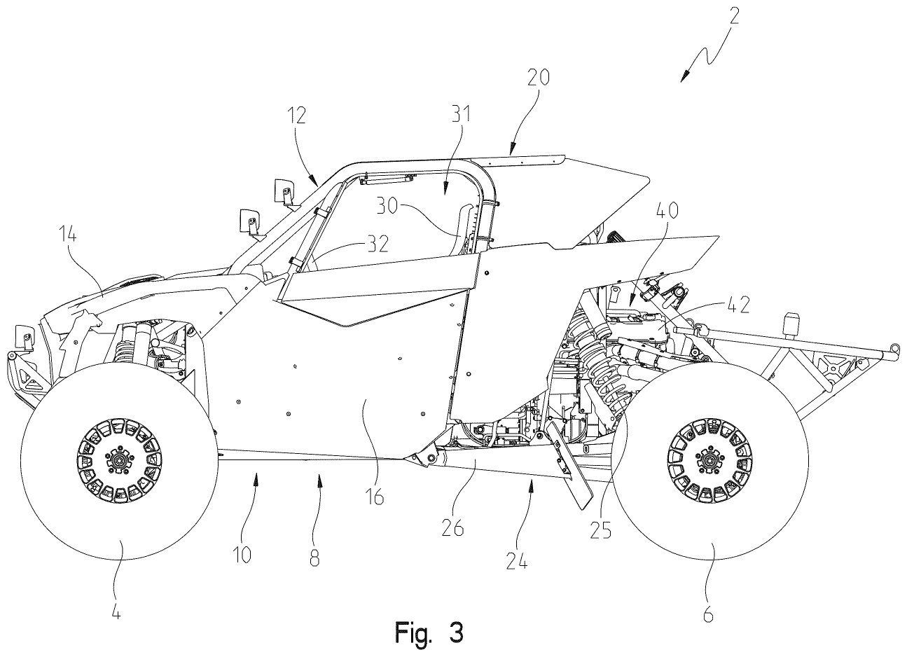

Referring to FIGS. 1-5, a vehicle 2 includes a plurality of ground engaging members 4, 6 including a pair of front ground engaging members 4 and a pair of rear ground engaging members 6. In embodiments, the ground engaging members 4, 6 may be wheels, skis, tracks, or other ground engaging members. The vehicle 2 includes a frame 8 supported by the ground engaging members 4, 6, and the frame 8 includes a chassis or lower frame 10 and an upper frame 12 coupled to the lower frame 10. In embodiments, lower frame 10 and upper frame 12 are separate assemblies. Frame 8 extends along a longitudinal centerline L1. In embodiments, lower frame 10 and upper frame 12 define a unitary assembly and are formed together. A body assembly 13 is supported by the frame 8 and includes a hood 14, a driver side door 16, a passenger side door 18, and a roof 20. The frame 8 defines an operator area 31 and upper frame 12 generally surrounds the operator area 31. In embodiments, the roof 20 is coupled to upper frame 12 and positioned vertically above the operator area 31. Vehicle 2 may also include at least one seat 30 positioned within operator area 31. In embodiments, vehicle 2 includes a driver seat 30 and a passenger seat 30.

Referring still to FIGS. 1-5, vehicle 2 includes a front suspension 22 coupled intermediate the frame 8 and the front ground engaging members 4 and a rear suspension 24 coupled intermediate the frame 8 and the rear ground engaging members 6. In embodiments, the front suspension 22 is a dual A-arm suspension including a plurality of control arms 21 (e.g., A-arms) and a pair of front shock absorbers 23 extending between the control arms 21 and the frame 8. In embodiments, front suspension 22 is a strut suspension or another type of suspension coupled between frame 8 and ground engaging members 4. In embodiments, the rear suspension 24 is an independent rear suspension such as a trailing arm suspension including a pair of rear shock absorbers 25 coupled between a pair of trailing arms 26, respectively, and the frame 8. Rear suspension 24 also includes a plurality of control arms 28 coupled between the rear ground engaging members 6 and the frame 8.

Referring still to FIGS. 1-5, vehicle 2 includes a steering input 32 operably coupled to the front ground engaging members 4. In embodiments, steering input 32 is operably coupled to at least one of ground engaging members 4, 6. In embodiments, steering input 32 is operable to control the steering angle of one or more of ground engaging members 4, 6. In embodiments, steering input 32 is operably coupled to a steering rack, a power steering assembly, or another steering assembly.

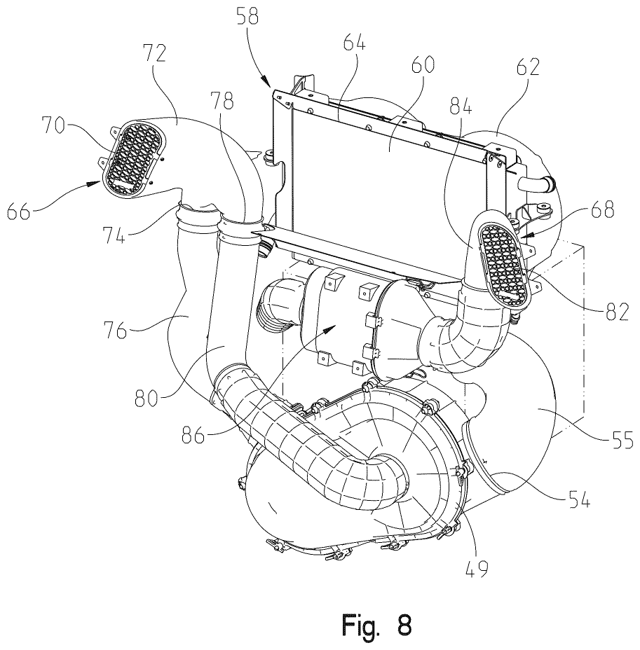

Referring to FIGS. 1-6, vehicle 2 includes a powertrain 40 supported by the frame 8 and positioned generally rearwardly of operator area 31. Powertrain 40 may be operably coupled to at least one ground engaging member 4, 6. In embodiments, powertrain 40 may be operably coupled to two ground engaging members 4, 6, three ground engaging members 4, 6, or four ground engaging members 4, 6. Powertrain 40 may include a prime mover 42 and a transmission 48. Prime mover 42 may comprise an internal combustion engine comprising a prime mover intake 44 and a prime mover exhaust 46. In embodiments, prime mover 42 is an electric motor operably coupled to one or more batteries (not shown). Transmission 48 may be a continuously variable transmission 48 including a drive clutch (not shown) and a driven clutch (not shown) and an endless member (e.g., a belt) extending between the drive clutch and the driven clutch. The prime mover 42 may be operably coupled to the drive clutch of the transmission 48 and the drive clutch may transfer power to the driven clutch. The continuously variable transmission 48 may include a housing 49 including a first intake inlet 50 and a second intake inlet 52. In embodiments, the continuously variable transmission 48 includes an exhaust outlet 54 and an exhaust conduit 55 (FIG. 8) coupled to the exhaust outlet 54. In embodiments, exhaust conduit 55 is directed to flow air over a portion of powertrain 40 (e.g., prime mover 42, exhaust of prime mover (not shown), or another portion of powertrain 40). In embodiments, powertrain 40 includes a shiftable transmission 56 operably coupled between continuously variable transmission 48 and ground engaging members 4, 6. In embodiments, transmission 48 includes an automatic transmission, a manual transmission, an automatic manual transmission, a dual clutch transmission, a steel belt continuously variable transmission, or another type of transmission.

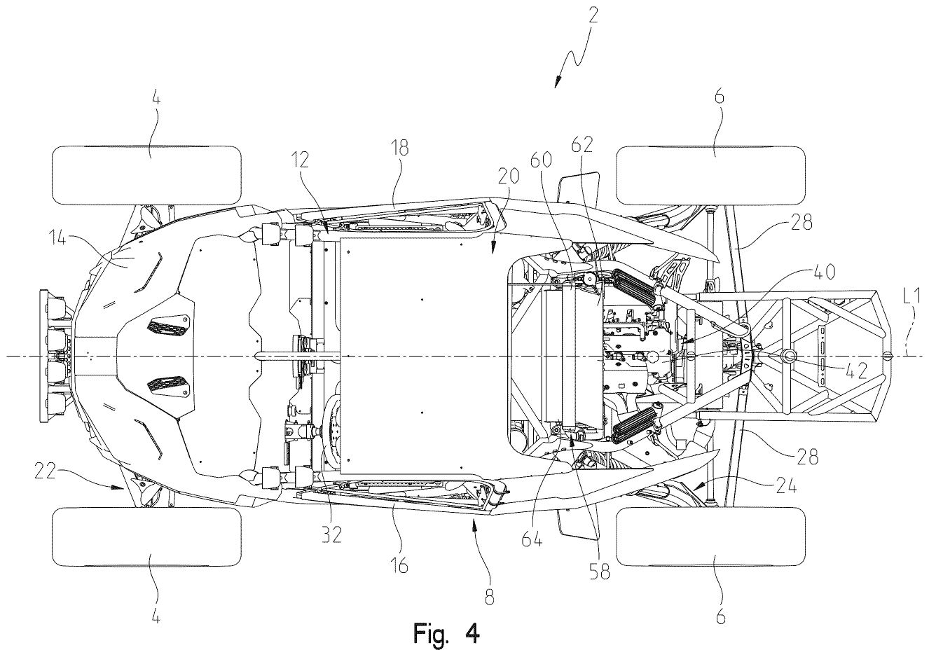

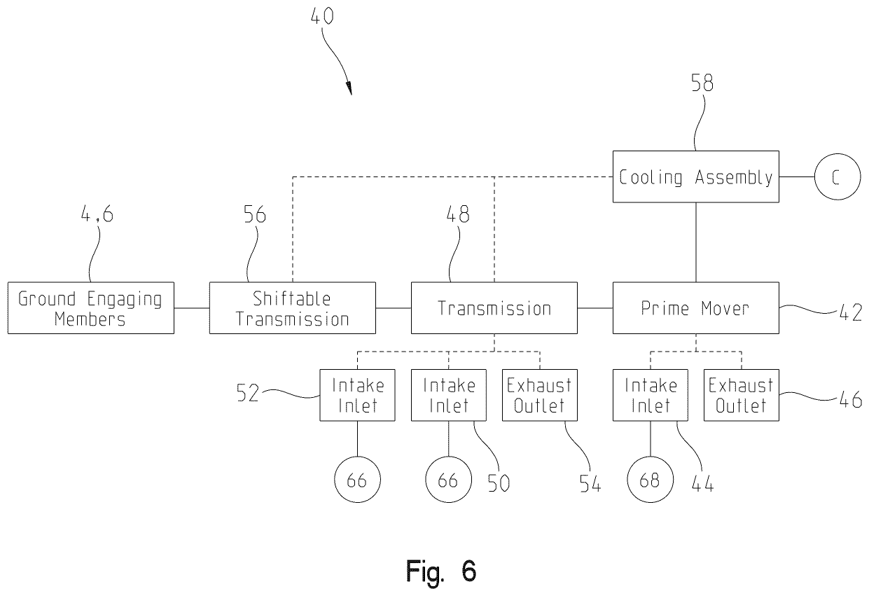

Referring to FIG. 6, a cooling assembly 58 may be operably coupled to one or more of the prime mover 42, transmission 48, and shiftable transmission 56. In embodiments, cooling assembly 58 includes a heat exchanger 60 (FIG. 4) operable to alter the temperature (e.g., cool) of coolant (e.g., water, antifreeze, etc.) flowing through the heat exchanger 60. A fan 62 is coupled to a rearward side of heat exchanger 60 and a shroud 64 is coupled to a forward extent of heat exchanger 60. Air may flow into shroud 64 and through heat exchanger 60 to alter the temperature (e.g., cool) of coolant (e.g., water, antifreeze, etc.) flowing through the heat exchanger 60. Coolant may then flow through one or more of prime mover 42, transmission 48, or shiftable transmission 56 to reduce the operating temperature thereof. In embodiments, heat exchanger 60 may be a radiator fluidly coupled to prime mover 42. In embodiments, heat exchanger 60 may be an intercooler operably coupled to a charged air device (not shown, e.g., a turbocharger, supercharger, etc.).

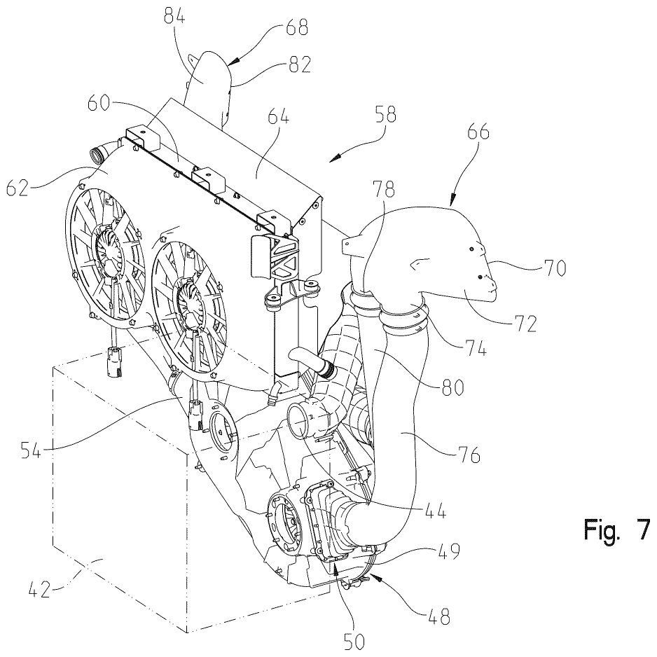

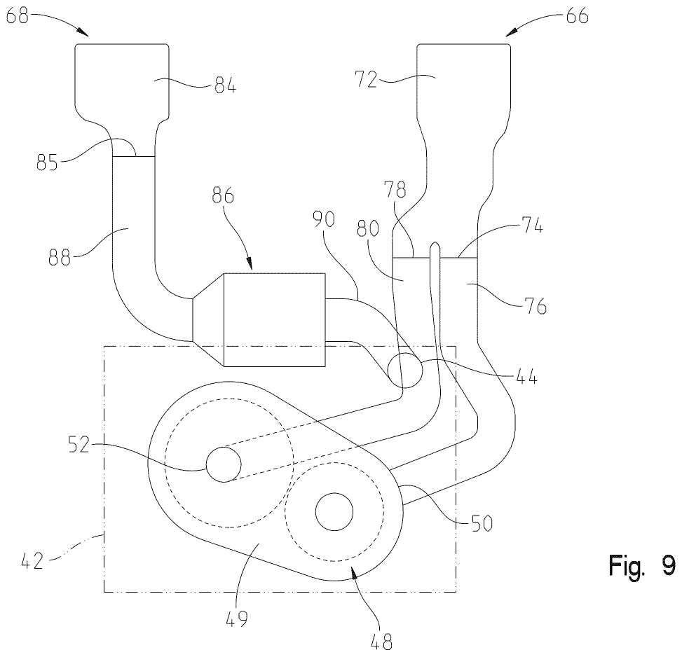

Referring to FIGS. 7-9, a transmission intake assembly 66 includes a housing 72 defining a transmission intake assembly inlet 70 facing generally forwardly (e.g., transmission intake assembly inlet 70 faces generally forwardly and parallel to the longitudinal centerline L1). Housing 72 defines a first outlet 74 and a second outlet 78 positioned generally below transmission intake assembly inlet 70. A first conduit 76 is coupled to first outlet 74 and extends between first outlet 74 and first intake inlet 50 of transmission 48 and a second conduit 80 is coupled to second outlet 78 and extends between second outlet 78 and second intake inlet 52 of transmission 48. In embodiments, first intake inlet 50 is positioned adjacent the drive clutch of the continuously variable transmission 48 and second intake inlet 52 is positioned adjacent the driven clutch of the continuously variable transmission 48. Further, a prime mover intake assembly 68 includes a housing 84 defining a prime mover intake assembly inlet 82 facing generally forwardly (e.g., prime mover intake assembly inlet 82 faces generally forwardly and parallel to the longitudinal centerline L1). Housing 84 defines an outlet 85 positioned generally below prime mover intake assembly inlet 82. In embodiments, a conduit 88 is coupled to outlet 85 and extends generally downwardly. An airbox 86 is fluidly coupled to conduit 88 such that air that flows into housing 84 flows into airbox 86. A conduit 90 is fluidly coupled to the airbox 86 and extends between the airbox 86 and the prime mover intake inlet 44. In embodiments, the airbox is positioned vertically lower than heat exchanger 60. In embodiments, transmission 48 is positioned vertically lower than airbox 86.

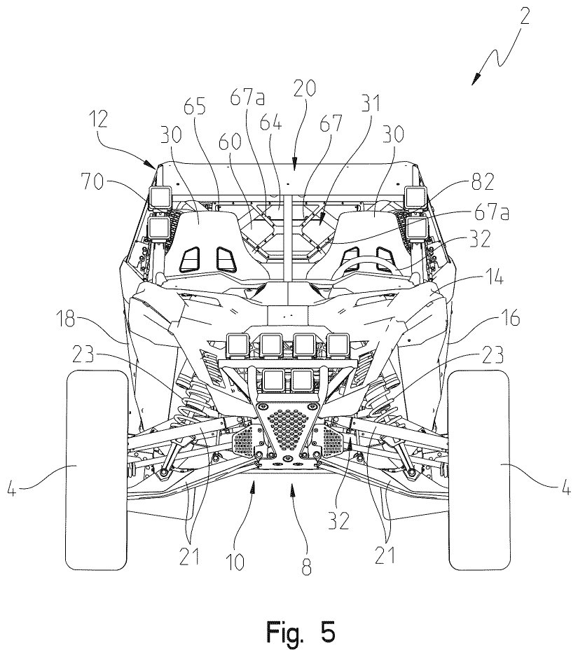

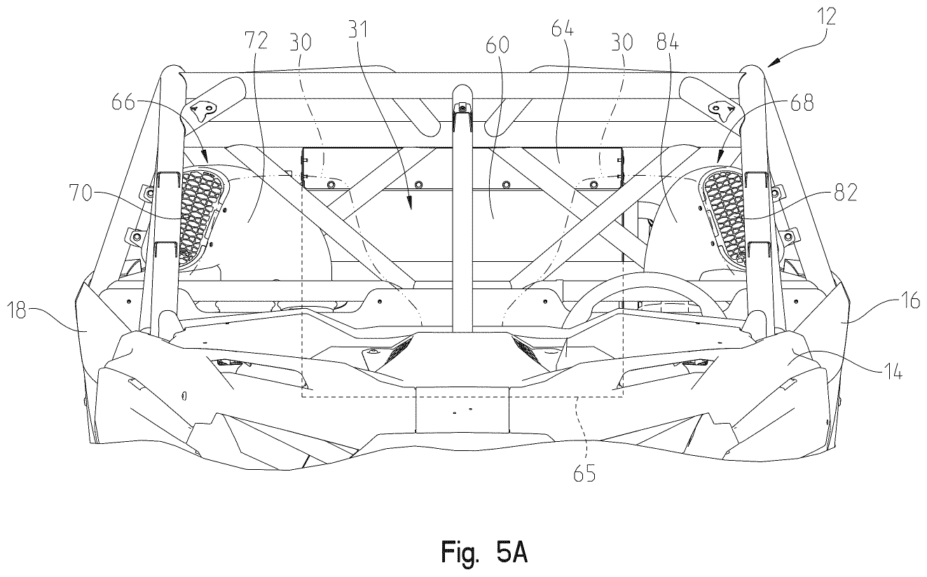

Referring now to FIGS. 5-5A, a cover 67 may be positioned over shroud 64 and cover 67 separates shroud 64 and heat exchanger 60 of cooling assembly 58 from operator area 31. In embodiments, cover 67 may have a plurality of cross-members (e.g., cross-members 67a), may be covered in a mesh (not shown, e.g., frogskin) or may have additional barriers, permeable barriers, or semi-permeable barriers. Cover 67 may be positioned longitudinally rearwardly from seats 30. In embodiments, shroud 64 defines a perimeter 65 which defines an entry area for air to flow into heat exchanger 60. In embodiments, perimeter 65 is laterally aligned with each of driver seat 30 and passenger seat 30. In embodiments, air may flow through operator area 31, flow through cover 67 (FIG. 5), and into shroud 64 and heat exchanger 60.

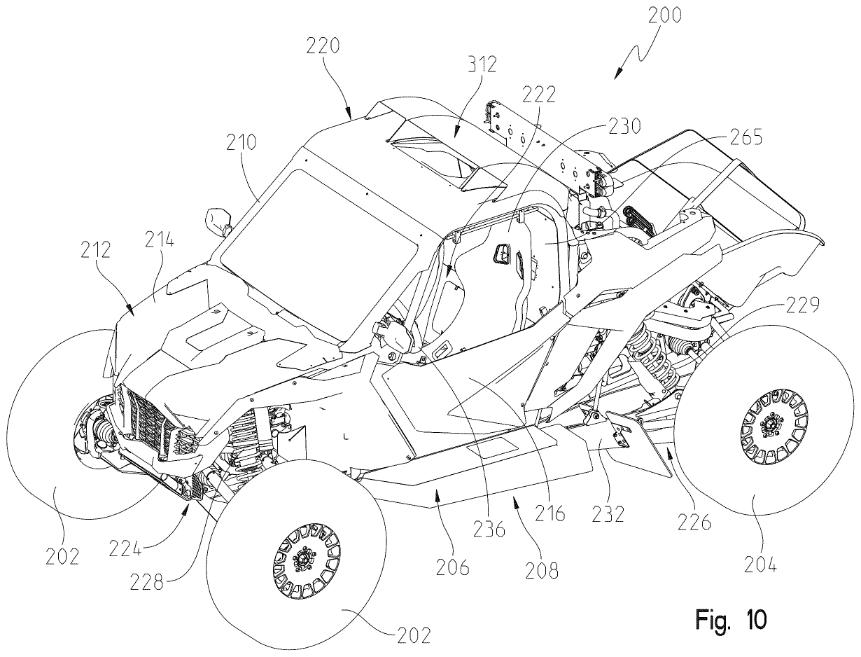

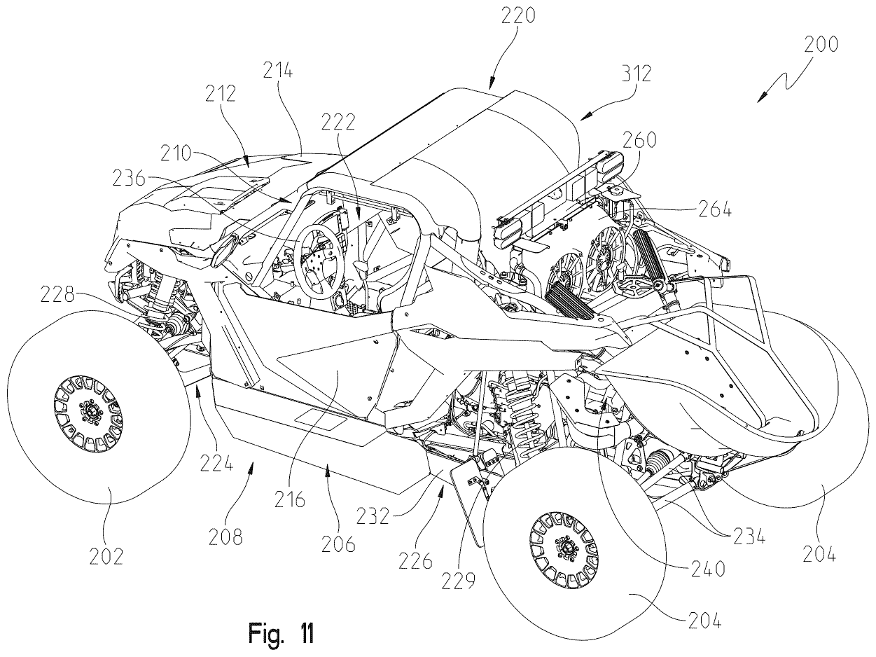

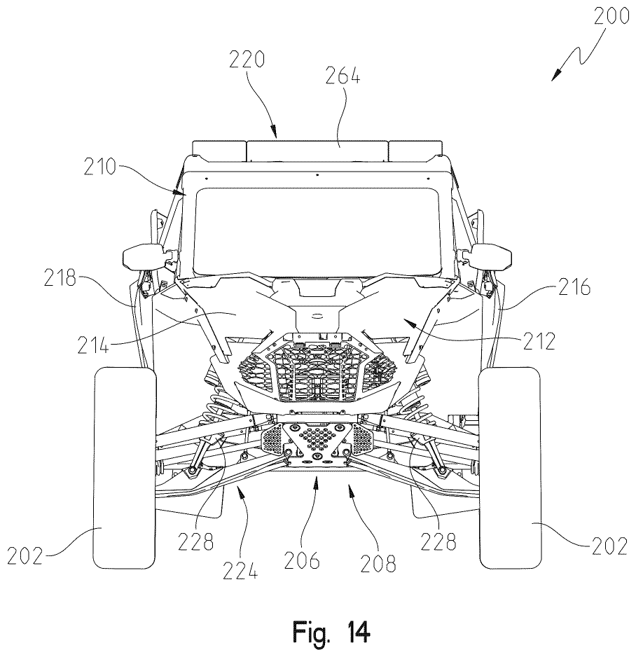

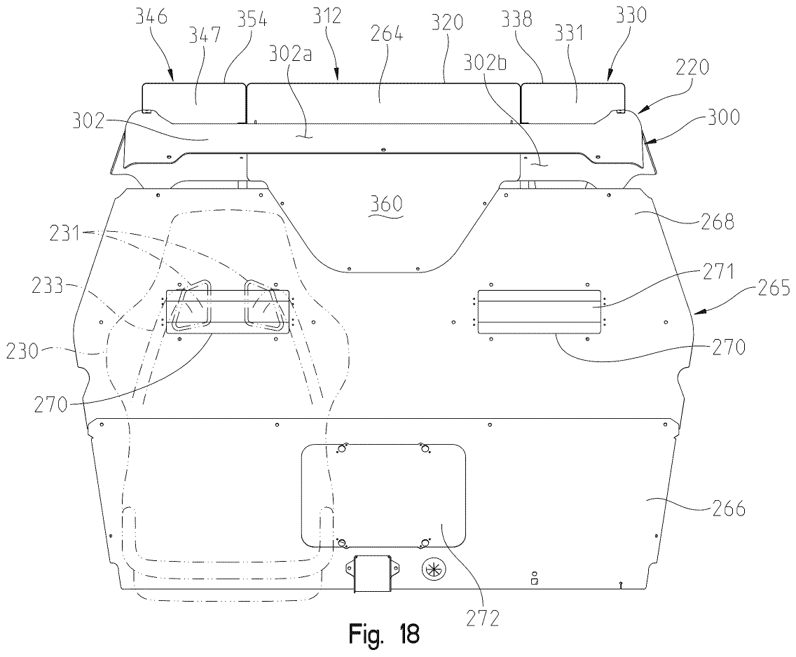

Referring now to FIGS. 10-14, a vehicle 200 includes a plurality of ground engaging members 202, 204 including a pair of front ground engaging members 202 and a pair of rear ground engaging members 204. In embodiments, the ground engaging members 202, 204 may be wheels, skis, tracks, or other ground engaging members. The vehicle 200 includes a frame 206 supported by the ground engaging members 202, 204 and the frame 206 includes a chassis or lower frame 208 and an upper frame 210 coupled to the lower frame 208. In embodiments, lower frame 208 and upper frame 210 are separate assemblies. In embodiments, lower frame 208 and upper frame 210 are unitary and formed together. A body assembly 212 includes a hood 214, a driver side door 216, a passenger side door 218, and a roof assembly 220. The frame 206 defines an operator area 222 and upper frame 210 generally surrounds the operator area 222. In embodiments, the roof assembly 220 is positioned vertically above the operator area 222. Vehicle 200 also includes at least one seat 230 positioned within operator area 222. In embodiments, vehicle 200 includes a driver seat 230 and a passenger seat 230. In embodiment, each seat 230 includes one or more apertures 231 (FIG. 18).

Referring still to FIGS. 10-14, vehicle 200 includes a front suspension 224 coupled intermediate the frame 206 and the front ground engaging members 202 and a rear suspension 226 coupled intermediate the frame 206 and the rear ground engaging members 204. In embodiments, the front suspension 224 is a dual A-arm suspension including a pair of front shock absorbers 228 extending between the A-arms and the frame 206. In embodiments, front suspension 224 is a strut suspension or another type of suspension coupled between frame 206 and ground engaging members 202. In embodiments, the rear suspension 226 is an independent rear suspension such as a trailing arm suspension including a pair of rear shock absorbers 229 coupled between a pair of trailing arms 232, respectively, and the frame 206. Rear suspension 226 also includes a plurality of control arms 234 coupled between the rear ground engaging members 204 and the frame 206.

Referring still to FIGS. 10-14, vehicle 200 includes a steering input 236 operably coupled to the front ground engaging members 202, 204. In embodiments, steering input 236 is operably coupled to at least one of ground engaging members 202, 204. In embodiments, steering input 236 is operable to control steering of one or more of ground engaging members 202, 204.

Referring to FIGS. 10-15, vehicle 2 includes a powertrain 240 (similar to powertrain 40) supported by the frame 206 and positioned generally rearwardly of operator area 222. Powertrain 240 may be operably coupled to at least one ground engaging member 202, 204. In embodiments, powertrain 240 may be operably coupled to two ground engaging members 202, 204, three ground engaging members 202, 204, or four ground engaging members 202, 204. Powertrain 240 may include a prime mover 242 and a transmission 248. Prime mover 242 may comprise an internal combustion engine comprising an intake assembly 244 and an exhaust assembly 246. In embodiments, prime mover 242 is an electric motor operably coupled to one or more batteries (not shown). Transmission 248 may be a continuously variable transmission 248 including a drive clutch (not shown) and a driven clutch (not shown) and an endless member (not shown) extending between the drive clutch and the driven clutch. The prime mover 242 may be operably coupled to the drive clutch and transfer power between the drive clutch and the driven clutch. The continuously variable transmission 248 may include a first intake inlet 250 and a second intake inlet 252. In embodiments, the continuously variable transmission 48 includes an exhaust outlet 254 and an exhaust conduit 255 coupled to the exhaust outlet 254. In embodiments, exhaust conduit 255 is directed to flow air over a portion of powertrain 240 (e.g., prime mover 242, exhaust of prime mover (not shown), or another portion of powertrain 240). In embodiments, powertrain 240 includes a shiftable transmission 256 operably coupled between continuously variable transmission 248 and ground engaging members 202, 204. In embodiments, transmission 248 includes an automatic transmission, a manual transmission, an automatic manual transmission, a dual clutch transmission, or another type of transmission.

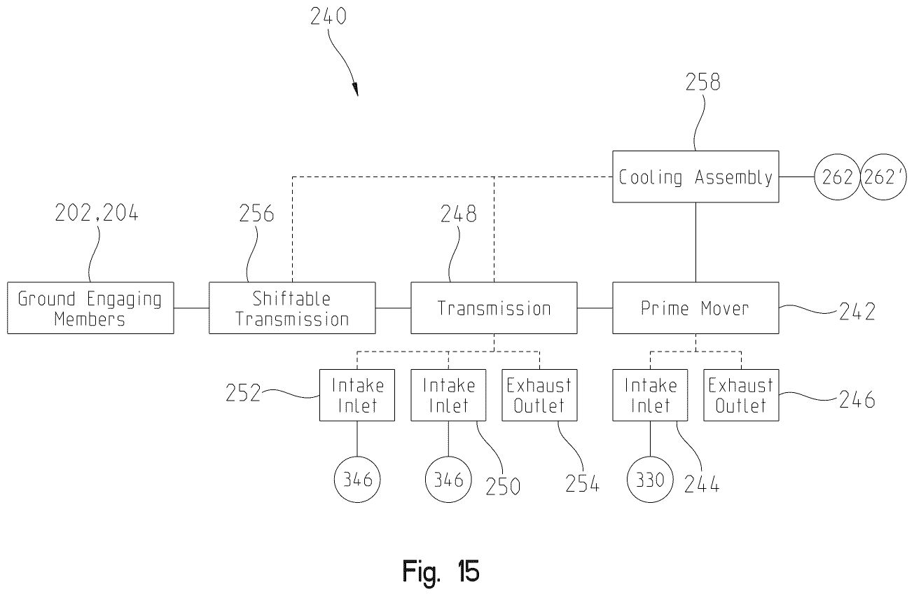

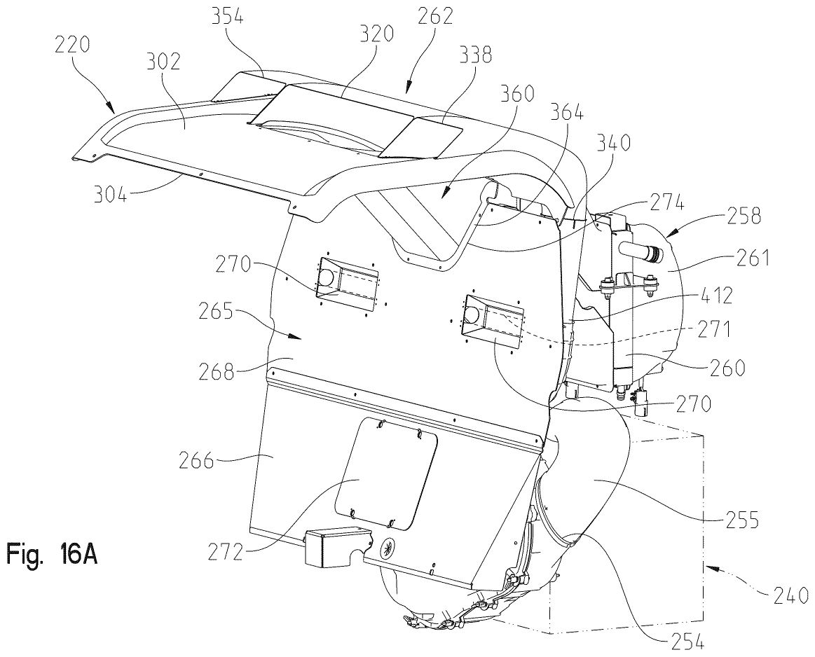

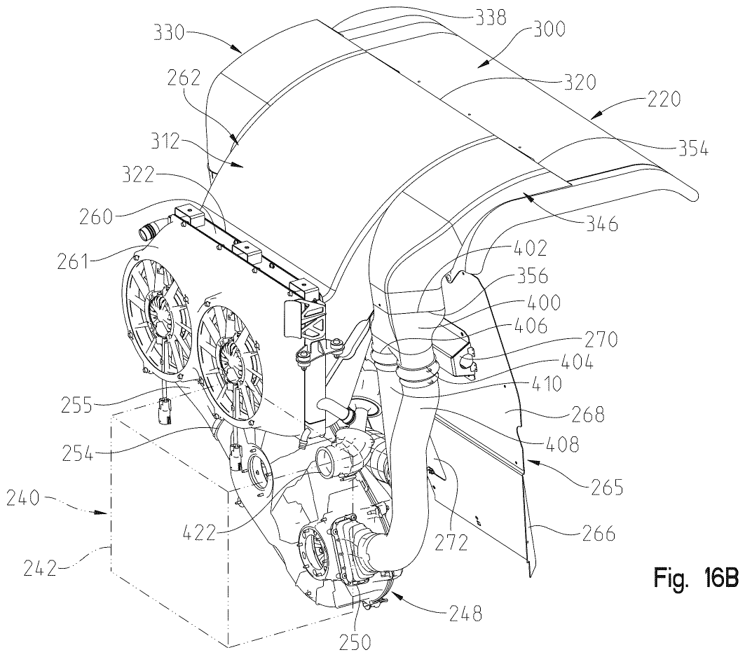

Referring to FIGS. 15-16B, powertrain assembly 240 includes a cooling assembly 258 which may be similar to cooling assembly 58. Cooling assembly 258 may be operably coupled to one or more of the prime mover 242, transmission 248, and shiftable transmission 256. In embodiments, cooling assembly 258 includes a heat exchanger 260 (FIG. 16B) operable to alter the temperature (e.g., cool) of coolant (e.g., water, antifreeze, etc.) flowing through the heat exchanger 260. A fan 261 is coupled to a rearward side of heat exchanger 260 and a shroud 262 is coupled to a forward extent of heat exchanger 260. Air may flow into shroud 262 and through heat exchanger 260 to alter the temperature (e.g., cool) of coolant (e.g., water, antifreeze, etc.) flowing through the heat exchanger 260. Coolant may then flow through one or more of prime mover 242, transmission 248, and shiftable transmission 256 to reduce the operating temperature thereof. In embodiments, heat exchanger 260 may be a radiator fluidly coupled to prime mover 242. In embodiments, heat exchanger 260 may be an intercooler operably coupled to a charged air device (not shown, e.g., a turbocharger, supercharger, etc.).

Referring again to FIG. 10, vehicle 2 includes a rear wall 265 positioned at a rearward extent of operator area 222. In embodiments, rear wall 265 separates operator area 222 from powertrain 240. Referring to FIG. 16A, rear wall 265 includes a first portion or lower portion 266 and a second portion or upper portion 268 coupled to the lower portion 266. Upper portion 268 defines two recessed portions 270 positioned rearwardly behind seats 230 (FIG. 18). In embodiments, each recessed portion 270 is positioned behind each of the driver seat 230 and passenger seat 230. In embodiments, each recessed portion 270 includes a frame member 271 coupled to upper portion 268 of rear wall 265 and extending laterally across the recessed portion 270. Referring to FIG. 18, seat belts (e.g., belts 233) may be mounted to frame member 271 behind seats 230 and extend through apertures 231 to secure a passenger (not shown) of seats 230. In embodiments, lower portion 266 defines a lower aperture (not shown) and a panel 272 may cover the lower aperture. Panel 272 may be removable from lower portion 266 to access one or more components of the powertrain 240. In embodiments, upper portion 268 of rear wall 265 includes a scalloped portion 274.

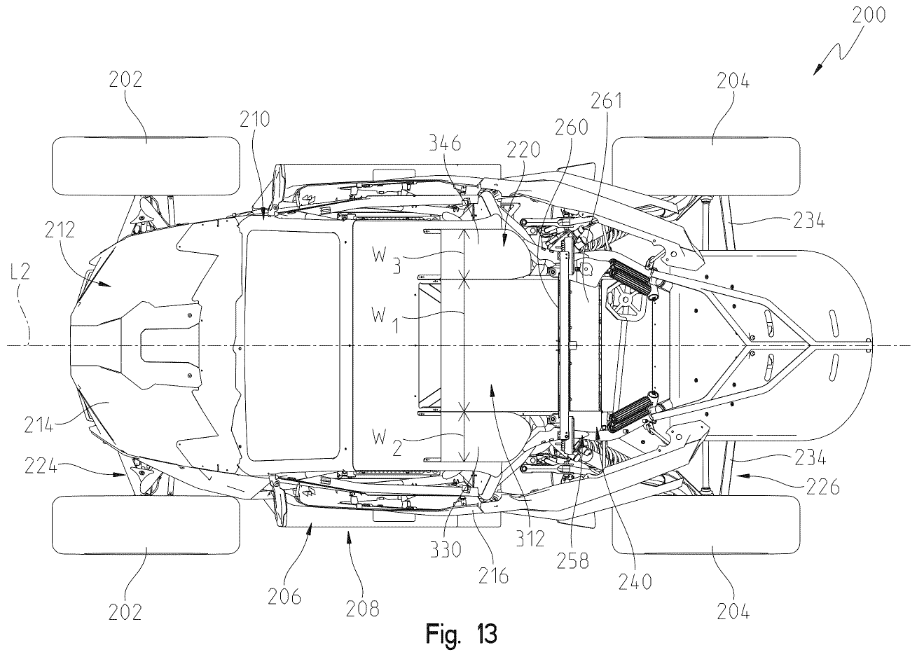

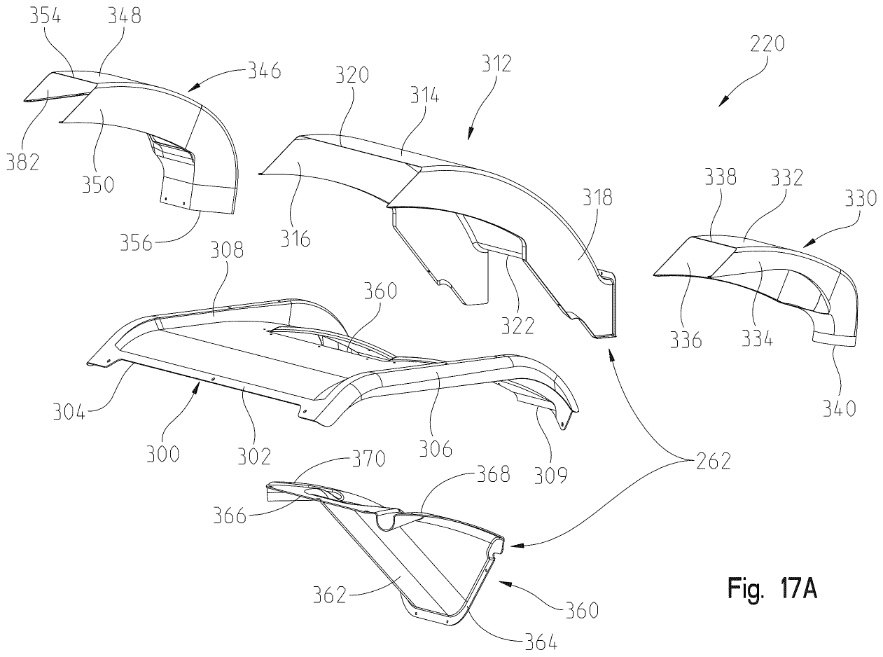

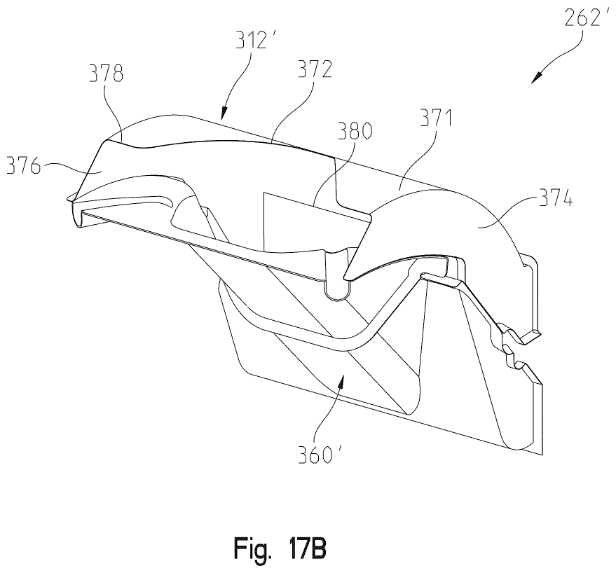

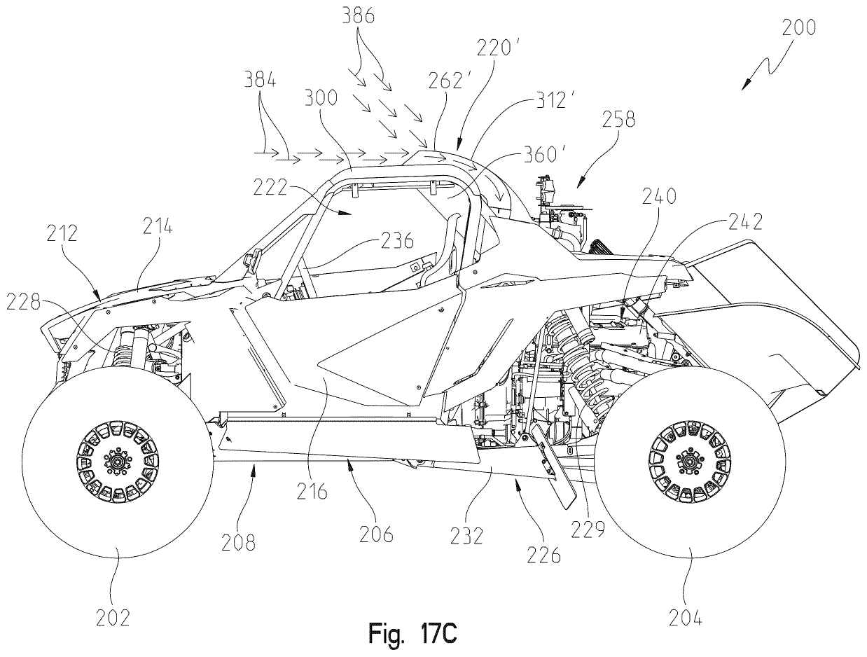

Referring now to FIGS. 16A-17A, roof assembly 220 includes a roof body portion 300, the first shroud portion 262, a second shroud portion 330, and a third shroud portion 346. Roof body portion 300 includes a body 302, a leading edge or front edge 304, a first side portion 306, a second side portion 308, a trailing edge or rear edge 309, and an opening 310 defined within the body 302. In embodiments, opening 310 is positioned within the rear edge 309. First shroud portion 262 includes an upper shroud 312 and a lower shroud 360. Upper shroud 312 includes a body 314, a first side wall 316 and a second side wall 318. Upper shroud 312 defines a front opening 320 and a rear opening 322. Upper shroud 312 may be coupled to an upper surface 302a of body 302 over opening 310. Lower shroud 360 includes a body portion 362, a bottom or rear edge portion 364, a front edge portion 366, a first side portion 368 and a second side portion 370. Lower shroud 360 is coupled to a lower surface 302b of body 302 below opening 310 such that the upper shroud 312 and lower shroud 360 create a channel or conduit 264 (FIG. 18) between opening 320 and a rear opening (not shown, e.g., at rear edge portion 364 of lower shroud 360). Lower shroud 360 is coupled to upper portion 268 of rear wall 265 such that air flowing through conduit 264 may flow to a position rearward of rear wall 265. In embodiments, shroud 262 is positioned along a longitudinal centerline L2 (FIG. 13).

Referring still to FIGS. 16A-17A, second shroud portion 330 includes a body portion 332, a first side or outer side portion 334, a second side or inner side portion 336, an inlet 338 defined by the body portion 332, outer side portion 334, and inner side portion 336, and an outlet 340 positioned lower than the inlet 338. In embodiments, second shroud portion 330 is coupled to body 302 of roof body portion 300 to create a channel or conduit 331 such that air may flow along body 302 of roof body portion 300, into inlet 338, through conduit 331, and out of outlet 340. In embodiments, second shroud portion 330 is positioned on a first side of the longitudinal centerline L2 (FIG. 13, e.g., on a driver side of vehicle 2).

Referring still to FIGS. 16A-17A, third shroud portion 346 includes a body portion 348, a first side or inner side portion 350, a second side or outer side portion 352, an inlet 354 defined by the body portion 348, inner side portion 350, and outer side portion 352, and an outlet 356 positioned lower than the inlet 354. In embodiments, third shroud portion 346 is coupled to body 302 of roof body portion 300 to create a channel or conduit 347 such that air may flow along body 302 of roof body portion 300, into inlet 354, through conduit 347, and out of outlet 356. In embodiments, third shroud portion 346 is positioned on a second side of the longitudinal centerline L2 (FIG. 13, e.g., on a passenger side of vehicle 200).

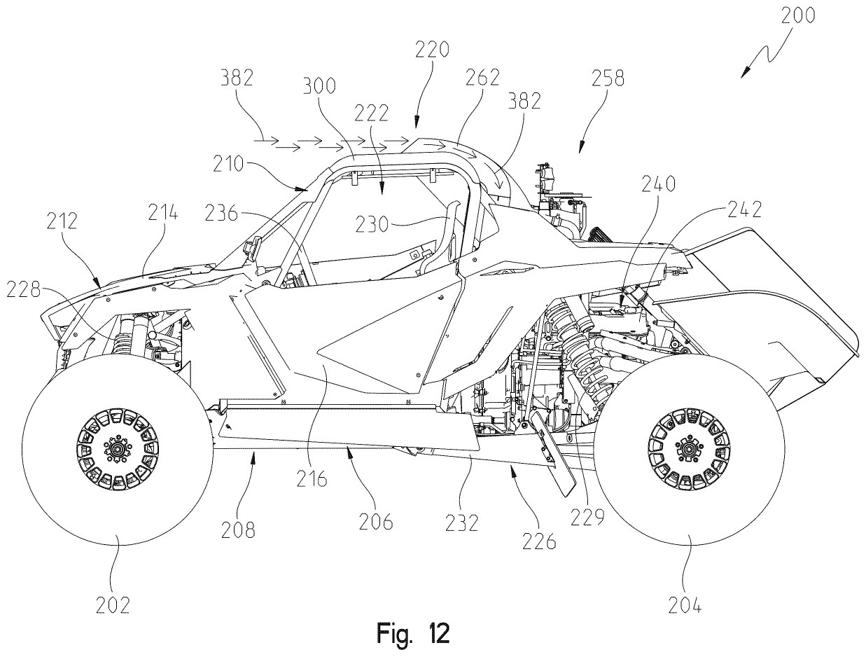

Referring again to FIG. 12, each of inlet 320 of shroud 262, inlet 338 of shroud 330, and inlet 354 of shroud 346 are positioned longitudinally forwardly of a rearwardmost extent of seat 230. In embodiments, each of inlet 320 of shroud 262, inlet 338 of shroud 330, and inlet 354 of shroud 346 are positioned longitudinally aligned with a portion of seat 230. In embodiments, each of inlet 320 of shroud 262, inlet 338 of shroud 330, and inlet 354 of shroud 346 are positioned longitudinally rearwardly of a forwardmost extent of seat 230. In embodiments, each of inlet 320 of shroud 262, inlet 338 of shroud 330, and inlet 354 of shroud 346 are positioned longitudinally rearwardly of steering input 236.

Referring again to FIG. 13, upper shroud 312 defines a width W1, second shroud portion 330 defines a width W2, and third shroud portion 346 defines a width W3. In embodiments, each of width W2 and width W3 are the same width. In embodiments, width W1 is greater than each of width W2 and width W3. In embodiments, a cross-sectional area of inlet 320 is greater than the cross-sectional area of each of inlet 338 and inlet 354.

Referring now to FIG. 17B, an alternative roof assembly 220′ (FIG. 17C) includes an alternative shroud portion 262′ may be similar to first shroud portion 262. Alternative shroud portion 262′ may include an alternative lower shroud 360′ and an alternative upper shroud 312′. In embodiments, alternative upper shroud 312′ includes a body 371, a first side portion 374, and a second side portion 376. In embodiments, alternative upper shroud 312′ defines an inlet 378 which includes a scalloped portion 372 and an outlet 380. In embodiments, alternative lower shroud 360′ is substantially similar to lower shroud 360, e.g., lower shroud 360′ couples to the lower surface 302b of body 302 and rear wall 265 to create a channel from upper shroud, through lower shroud, and behind rear wall 265.

Referring again to FIGS. 16A-16B, each of roof assembly 220 and alternative roof assembly 220′ are fluidly coupled to cooling assembly 258, transmission 248 and prime mover 242. That is, a housing 400 includes an inlet 402, a first outlet 404, and a second outlet 406. Inlet 402 is coupled to outlet 356 of third shroud portion 346. A first conduit 408 is coupled between first outlet 404 and first intake inlet 250 of transmission 248 and a second conduit 410 is coupled between second outlet 406 and second intake inlet 252 of transmission 248. Air may flow into inlet 354 of third shroud portion 346, through third shroud portion 346, and through each of first conduit 408 and second conduit 410 and into transmission 248 to provide cooling air to one or more of the drive clutch and driven clutch of transmission 248. In embodiments, each of conduits 408, 410 extend downwardly from roof assembly 220, behind rear wall 265 on the passenger side of vehicle 200. In embodiments, each of conduits 408, 410 extend downwardly adjacent the recessed portion 270 on the passenger side of vehicle 200.

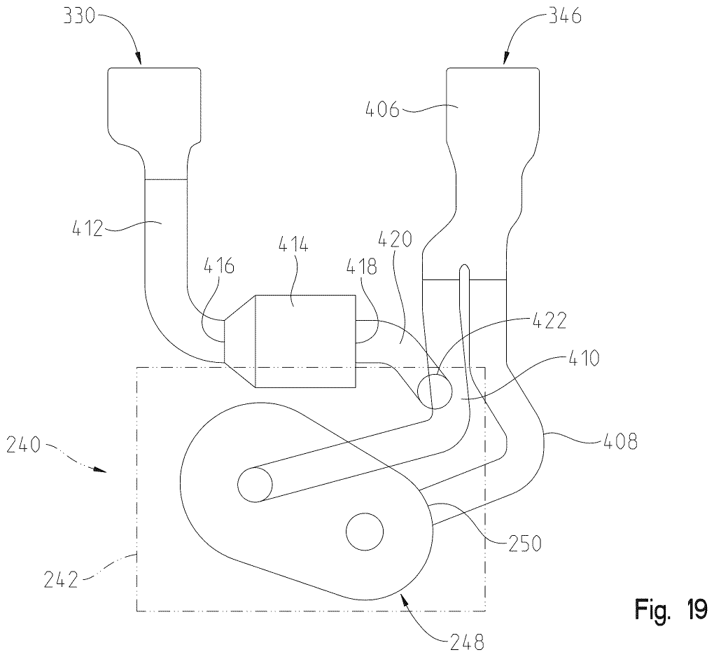

Still referring to FIGS. 16A-16B, a conduit 412 is coupled to the outlet 340 of second shroud portion 330. An airbox 414 includes an inlet 416 and an outlet 418, and conduit 412 is coupled between outlet 340 and inlet 416 of airbox 414. Airbox 414 may include an air filter to clean the air flowing into the air intake of prime mover 242. A conduit 420 (FIG. 19) is coupled between outlet 418 of airbox 414 and the prime mover 242. Air may flow into inlet 338 of second shroud portion 330, through second shroud portion 330, and through conduit 412 and airbox 414 and into prime mover 242 to provide clean air to cylinders of the prime mover 242. In embodiments, conduit 412 extends downwardly from roof assembly 220, behind rear wall 265 on the driver side of vehicle 200. In embodiments, conduit 412 extends downwardly adjacent the recessed portion 270 on the driver side of vehicle 200.

Referring again to FIG. 12, an air flow path 382 flows along roof assembly 220 and into each of the inlet 320 of first shroud 262, inlet 338 of second shroud 330, and inlet 354 of third shroud 346. Air flow path 382 may then split and flow to each of the cooling assembly 258, the prime mover 242, and the transmission 248. In embodiments, air flow path 382 is generally horizontal to roof body 302. In embodiments, air flow path 382 is generated at least in part by fan 261 pulling air through heat exchanger 260 from first shroud 262. In embodiments, air flow path 382 is generated at least in party by vehicle 200 moving forward and air flowing through shrouds 262, 330, 346 (e.g., RAM air).

Referring now to FIG. 17C, a first air flow path 384 flows along roof assembly 220 and into each of the inlet 378 of alternate first shroud 262′, inlet 338 of second shroud 330, and inlet 354 of third shroud 346 and a second air flow path 386 flows downwardly into inlet 378 of alternate first shroud 262′ (e.g., through scalloped portion 372). That is, the inlet 378 is increased in size by scalloped portion 372 and the path between inlet 378 and outlet 380 is less tortuous thereby allowing fan 261 to more pull air through alternate shroud 262′ when vehicle 200 is standing still, or not moving. Air flow path 384 may then split and flow to each of the cooling assembly 258, the prime mover 242, and the transmission 248 and air flow path 386 may flow to the cooling assembly 258. In embodiments, air flow path 384 is generated at least in party by vehicle 200 moving forward and air flowing through shrouds 262, 330, 346 (e.g., RAM air). In embodiments, air flow path 386 is generated at least in party by fan 261 pulling air through shroud 262′.

Additional details regarding vehicle 2, 200 may be found in U.S. patent application Ser. No. 18/405,756, filed Jan. 5, 2024, the complete disclosure of which is incorporated by reference herein.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a plurality of ground engaging members;
a frame supported by the plurality of ground engaging members, the frame defining an operator area;
a powertrain supported by the frame, the powertrain comprising:
a prime mover including a prime mover air inlet; and
a transmission operably coupled between the prime mover and at least one ground engaging member of the plurality of ground engaging members, the transmission comprising a transmission air inlet; and
a roof supported by the frame, the roof defining a first roof inlet fluidly coupled with the prime mover air inlet and a second roof inlet fluidly coupled with the transmission air inlet.

2. The vehicle of claim 1, wherein the roof comprises a body portion and a first shroud portion spaced from a body portion, the first shroud portion and the body portion defining at least a portion of the first roof inlet.

3. The vehicle of claim 2, wherein the roof comprises a second shroud portion, and the second shroud portion and the body portion define at least a portion of the second roof inlet.

4. The vehicle of claim 3, wherein the roof comprises a third shroud portion positioned laterally intermediate the first shroud portion and the second shroud portion.

5. The vehicle of claim 4, further comprising a cooling assembly operably coupled with the prime mover, and the third shroud portion defines a third roof inlet fluidly coupled with the cooling assembly.

6. The vehicle of claim 1, wherein the first roof inlet is laterally spaced from the second roof inlet.

7. The vehicle of claim 6, further comprising a cooling assembly and the roof defines a third roof inlet, and the third roof inlet is fluidly coupled with a portion of the cooling assembly.

8. The vehicle of claim 7, further comprising a first shroud portion coupled to the roof and extending generally downwardly into the operator area, and the operator area being partially defined by a rear wall, the first shroud portion extending between the roof and the rear wall.

9. The vehicle of claim 8, wherein the first shroud portion defines a portion of a cooling system channel extending between the third roof inlet and the cooling assembly.

10. The vehicle of claim 7, wherein each of the first roof inlet, second roof inlet, and third roof inlet are laterally spaced apart.

11. The vehicle of claim 7, wherein the third roof inlet is positioned laterally intermediate the first roof inlet and the second roof inlet.

12. The vehicle of claim 7, wherein the third roof inlet has a lateral width greater than a lateral width of the first roof inlet or the second roof inlet.

13. A vehicle, comprising:
a plurality of ground engaging members;
a frame supported by the plurality of ground engaging members, the frame defining an operator area;
a powertrain supported by the frame, the powertrain comprising:
a prime mover including a prime mover air inlet;
a transmission operably coupled between the prime mover and at least one ground engaging member of the plurality of ground engaging members, the transmission comprising at least one transmission air inlet; and
a plurality of conduits comprising at least one conduit fluidly coupled with the prime mover air inlet and at least one conduit fluidly coupled with the at least one transmission air inlet; and
a roof supported by the frame and positioned above the operator area, the roof defining a plurality of inlets including a first portion of inlets and a second portion of inlets, wherein the first portion of inlets is fluidly coupled to at least a first conduit of the plurality of conduits and the second portion of inlets is fluidly coupled to at least a second conduit of the plurality of conduits.

14. The vehicle of claim 13, wherein the plurality of inlets are vertically aligned.

15. The vehicle of claim 14, wherein the plurality of inlets are laterally spaced.

16. The vehicle of claim 13, wherein the at least one transmission air inlet includes a first transmission air inlet and a second transmission air inlet, and the first portion of inlets is fluidly coupled to the first conduit of the plurality of conduits and a third conduit of the plurality of conduits, the first conduit fluidly coupled with the first transmission air inlet and the second conduit fluidly coupled with the second transmission air inlet.

17. The vehicle of claim 16, wherein the roof includes a first shroud portion and a second shroud portion laterally spaced from the first shroud portion, each of the first shroud portion and second shroud portion defining separate inlet of the plurality of inlets.

18. The vehicle of claim 13, wherein the plurality of inlets includes a third portion of inlets, and the third portion of inlets is positioned laterally intermediate the first portion of inlets and the second portion of inlets.

19. The vehicle of claim 18, further comprising a cooling assembly operably coupled to the powertrain, and the third portion of inlets is fluidly coupled to the cooling assembly.

20. The vehicle of claim 13, wherein the first portion of inlets includes a first inlet, the second portion of inlets includes a second inlet, and a third portion of inlets includes a third inlet, and the first inlet is fluidly coupled with the prime mover air inlet, the second inlet is fluidly coupled with the transmission air inlet, and the third inlet is fluidly coupled with a cooling assembly.

21. The vehicle of claim 20, wherein the cooling assembly comprises a radiator, and the transmission is positioned vertically lower than the radiator.

22. A roof assembly, comprising:
a body member;
a first shroud portion coupled to the body member, a first inlet defined by the first shroud portion and the body member; and
a second shroud portion coupled to the body member, a second inlet defined by the second shroud portion and the body member.

23. The roof assembly of claim 22, further comprising a third shroud portion coupled to the body member, a third inlet defined by the third shroud portion and the body member.

24. The roof assembly of claim 23, wherein the first inlet is positioned laterally intermediate the second inlet and the third inlet.

25. The roof assembly of claim 24, wherein the first inlet has a first width, the second inlet has a second width, the third inlet has a third width, and the first width is greater than the second width and the third width.

26. The roof assembly of claim 22, further comprising a third shroud coupled to the body member, an outlet defined by the third shroud, and a channel defined between the first inlet and the outlet by each of the first shroud portion, the body member, and the third shroud.

27. The roof assembly of claim 26, wherein the third shroud extends below the body member.
